(19) United States
(12) Patent Application Publication
(10) Pub. No.: US 2014/0286674 A1
(43) Pub. Date: Sep. 25, 2014

(54) APPARATUS AND METHOD FOR MANUFACTURING THERMAL TRANSFER PRINT SHEET

(71) Applicants: CASIO COMPUTER CO., LTD., Tokyo (JP); CASIO ELECTRONICS MANUFACTURING CO., LTD., Iruma-shi (JP)

(72) Inventors: Satoshi MITSUI, Tokyo (JP); Masaru SATO, Tokyo (JP); Tomohumi SANO, Iruma-shi (JP)

(73) Assignees: CASIO COMPUTER CO., LTD., Tokyo (JP); CASIO ELECTRONICS MANUFACTURING CO., LTD., Iruma-shi (JP)

(21) Appl. No.: 14/221,607

(22) Filed: Mar. 21, 2014

(30) Foreign Application Priority Data
Mar. 22, 2013 (JP) 2013-060720

(51) Int. Cl. G03G 15/22

(52) U.S. Cl. CPC B41M 5/00
USPC 399/130

(57) ABSTRACT

An apparatus for manufacturing a thermal transfer print sheet includes an image forming unit configured to form a film pattern including a first pattern and a second pattern on a releasing sheet, the first and second patterns being arranged to at least partially overlap each other, the first pattern being formed of toner that includes a binder resin having a first thermoplastic resin, the second pattern being formed of toner that includes a binder resin having a second thermoplastic resin that is in a homologous relation to the first thermoplastic resin, and a fixing unit configured to apply heat and pressure to the film pattern such that the film pattern is formed as a thermal transfer film releasably supported on the releasing sheet.

### CROSS-REFERENCE TO RELATED APPLICATION

This application claims the benefit of priority from prior Japanese Patent Application No. 2013-060720, filed on Mar. 22, 2013, which is incorporated herein by reference in its entirety.

### BACKGROUND OF THE INVENTION

1. Field of the Invention

The present invention relates to an apparatus and a method for manufacturing a thermal transfer print sheet.

2. Description of the Prior Art

In general, labels are manufactured by the following method. First, a label paper is prepared. The label paper has an adhesive layer on one side thereof, and the adhesive layer is covered with a release paper. Subsequently, a desired design is printed on the label paper and then the label paper is cut into a desired shape.

Other methods for manufacturing labels include printing a desired design on a release paper having an overcoat of an adhesive made of an ultraviolet curing resin, and irradiating an exposed surface of the adhesive layer with ultraviolet rays, as disclosed in JP2007-283745A, JP2010-184470A, and JP2011-107418A.

As a technique relevant to thermal transfer printing, a method for preparing a transfer paper formed by disposing a hot-melt resin layer on the release paper, printing a design on the hot-melt resin layer using a thermal printer and an ink ribbon that uses an ink containing a subliming or evaporating dye, and thermally transferring the hot-melt resin layer to an object to be printed from the transfer paper with the dye has been proposed, for example, in JP05-077557A.

In the above method accompanying the cutting of a label sheet, however, both a plate for printing designs and a blade die such as a punching die for cutting the label sheet are required, whereby the cost of the manufacturing apparatus is increased. On the other hand, in the method of manufacturing labels using ultraviolet rays, the use of the ultraviolet curing adhesive is of no use in itself.

In the thermal transfer method using the ink containing a subliming or evaporating dye, the type of dyes that can be used is limited. In addition, since the transfer papers are mostly in a fixed size (such as A4 and A3), the use of a foil stamping die having a corresponding shape that matches a pattern to be transferred is required for thermal transfer from the transfer paper to the object to be printed.

### SUMMARY OF THE INVENTION

The present invention has been made in view of the above situations, and it is an object of the invention to provide an apparatus and a method for manufacturing a thermal transfer print sheet, in which there is less limitation in selecting a coloring agent and a thermal transfer print sheet can be manufactured at a low price.

According to a first aspect of the present invention, there is provided an apparatus for manufacturing a thermal transfer print sheet, including an image forming unit configured to form a film pattern including a first pattern and a second pattern on a releasing sheet, one of the first and second patterns being arranged to at least partially overlap, the first pattern being formed of toner that includes a binder resin having a first thermoplastic resin, the second pattern being formed of toner that includes a binder resin having a second thermoplastic resin that is in a homologous relation to the first thermoplastic resin, and a fixing unit configured to apply heat to the film pattern such that the film pattern is formed as a thermal transfer film releasably supported on the releasing sheet.

According to a second aspect of the present invention, there is provided a method for manufacturing a thermal transfer print sheet, including the steps of forming a film pattern including a first pattern and a second pattern on a releasing sheet, one of the first and second patterns being arranged to at least partially overlap, the first pattern being formed of toner that includes a binder resin having a first thermoplastic resin, the second pattern being formed of toner that includes a binder resin having a second thermoplastic resin that is in a homologous relation to the first thermoplastic resin, and applying heat to the film pattern such that the film pattern is formed as a thermal transfer film releasably supported on the releasing sheet.

### BRIEF DESCRIPTION OF THE DRAWINGS

FIG. 1 is a schematic view showing an internal structure of an apparatus for manufacturing a thermal transfer print sheet according to an embodiment of the present invention;

FIG. 2 is a perspective view showing a charging process in the manufacturing apparatus of FIG. 1;

FIG. 3 is a perspective view showing an exposing process in the manufacturing apparatus of FIG. 1;

FIG. 4 is a perspective view showing a developing process in the manufacturing apparatus of FIG. 1;

FIG. 5 is a perspective view showing a transferring process in the manufacturing apparatus of FIG. 1;

FIG. 6 is a perspective view showing a fixing process in the manufacturing apparatus of FIG. 1;

FIG. 7 is a cross-sectional view schematically showing an example of a thermal transfer print sheet that can be manufactured by the apparatus for manufacturing a thermal transfer print sheet according to an embodiment;

FIG. 8 is a cross-sectional view schematically showing an example of a thermal transfer print sheet that can be manufactured by the apparatus for manufacturing a thermal transfer print sheet according to another embodiment; and

FIG. 9 is a cross-sectional view schematically showing an example of a thermal transfer print sheet that can be manufactured by the apparatus for manufacturing a thermal transfer print sheet according to a comparative example.

### DESCRIPTION OF THE PREFERRED EMBODIMENTS

Embodiments of the present invention will be described in detail with reference to the accompanying drawings.

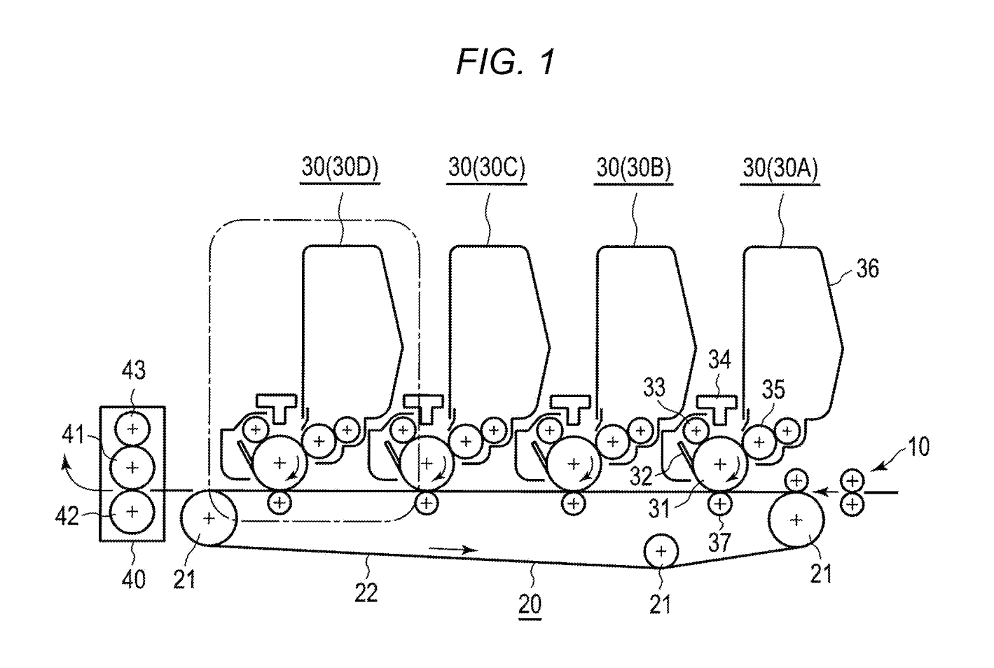

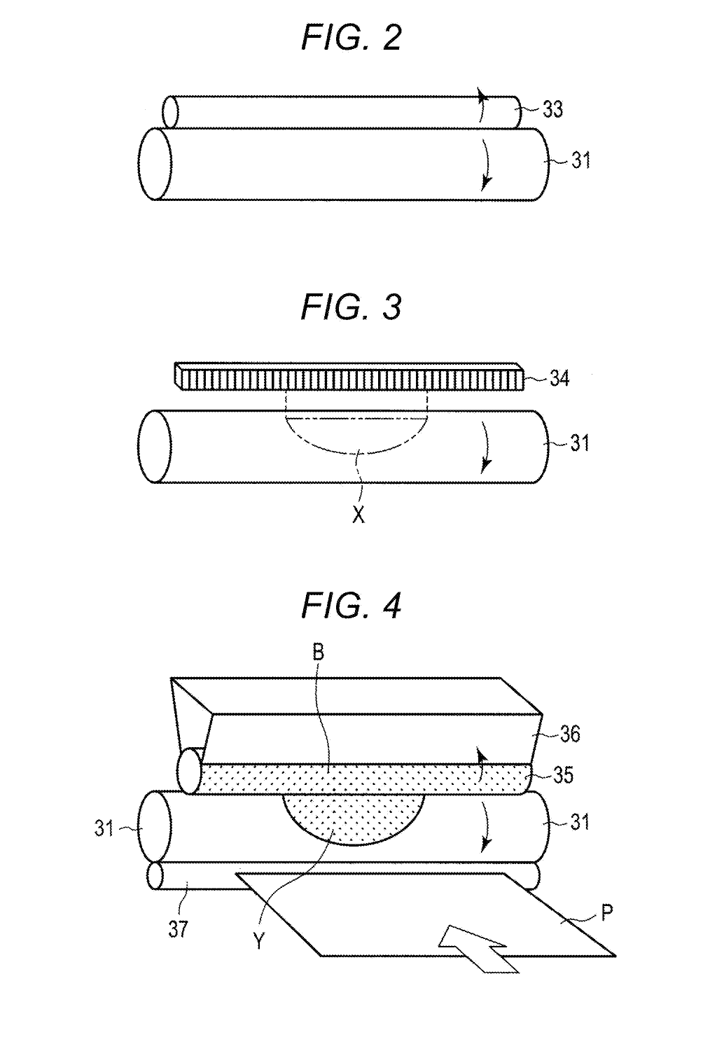

FIG. 1 is a schematic view showing an internal structure of an apparatus 1 for manufacturing a thermal transfer print sheet according to an embodiment of the present invention. FIGS. 2 to 6 are perspective views showing manufacturing processes of a thermal transfer print sheet by the apparatus 1 for manufacturing a thermal transfer print sheet. In the following description, S indicates a thermal transfer print sheet, F indicates a thermal transfer film, P indicates a releasing sheet, and B indicates base toners of colors such as magenta (M), cyan (C), and yellow (Y).

The apparatus 1 for manufacturing a thermal transfer print sheet includes a releasing sheet feeder 10, a transportation mechanism 20, a plurality of image forming units 30, and a fixing unit 40.

A releasing sheet P is fed from the releasing sheet feeder 10 onto a transfer belt 22 provided in the transportation mechanism 20.

The releasing sheet P having a low surface energy and a good releasing characteristic is used. In general, papers used as releasing sheets or films can be used. The releasing sheet P can be used repeatedly. Typically, a film-type sheet is used.

Since the film-type releasing sheet is used, an interface between the releasing sheet and the thermal transfer film easily has an improved smoothness after fixing, compared to using the paper-type sheet. Further, due to a high durability, this type of sheet could withstand an increased number of repeated use.

The transportation mechanism 20 includes a plurality of drive rollers 21 and a transfer belt (endless belt) 22 stretching over the drive rollers 21 and a transfer roller 37 which will be described below.

Each of the image forming units 30 includes a photosensitive drum 31 having a photosensitive material formed on the surface thereof, a doctor blade 32 arranged to surround the periphery of the photosensitive drum 31 in a circumferential direction, a charging roller 33, an exposing head 34 formed by an LED head, a developing roller 35, a toner tank 36 that is filled with toner to supply it to the developing roller 35, and a transfer roller 37 located on the lower side of the transfer belt 22. The transfer roller 37 is pressed against the photosensitive drum 31 to sandwich the releasing sheet P and the transfer belt 22 therebetween, and transfers toner onto the releasing sheet P.

Typically, one or more image forming units serving as first image forming units to supply a base toner B, and an image forming unit serving as a second image forming unit for supplying a film tonner are arranged in this order. The toner tanks 36 of the image forming units 30A to 30C store base toners B of M, C, and Y, respectively, and the toner tank 36 of the image forming unit 30D stores the film toner. The base toner B and the film toner may be put in any toner tank 36 of the image forming units 30A to 30D. For example, the toner tank 36 of the image forming unit 30A may store the film toner, and the toner tanks 36 of the image forming units 30B to 30D may store the base toners B of M, C, and Y, respectively.

In this embodiment, black color may also be expressed using process black that is made by mixing M, C, and Y. It is also possible to serially arrange the apparatus 1 for manufacturing a thermal transfer print sheet and another apparatus for manufacturing a thermal transfer print sheet, and execute black color printing or printing using a base toner of a characteristic color in the additional apparatus for manufacturing a thermal transfer print sheet. In this case, the fixing process may be carried out only in the latter apparatus for manufacturing a thermal transfer print sheet. Alternatively, the fixing process may be carried out twice; one time in the one apparatus for manufacturing a thermal transfer print sheet immediately after transferring toner to the releasing sheet P, and the second time in the other apparatus for manufacturing a thermal transfer print sheet immediately after transferring toner to the releasing sheet P.

The fixing unit 40 at which the fixing process is carried out includes a pair of fixing rollers 41 and 42, and an oil application roller 43 that abuts the upper fixing roller 41.

In the apparatus 1 for manufacturing a thermal transfer print sheet having a structure as described above, a thermal transfer print sheet S is manufactured as described below. Data such as the shape of the thermal transfer film F or letters to be printed, etc. is created in advance using a PC or the like, and input to the apparatus 1 for manufacturing a thermal transfer print sheet.

First, the releasing sheet P is supplied to the image forming unit 30A located at an upstream side. The photosensitive drum 31 is rotated in a direction indicated by an arrow (clockwise) in FIG. 1, and a photosensitive material of the photosensitive drum 31 is charged by the charging roller 33 as shown FIG. 2.

Next, as shown in FIG. 3, the surface of the photosensitive drum 31 is exposed by the exposing head 34 to form a pattern having an arbitrary shape, and a non-charged portion where charges are offset and a latent image X that is a charged portion having a surface potential difference are defined.

Next, as shown in FIG. 4, a base toner B is supplied from the toner tank 36 while stirred by the rotation of the developing roller 35, and attached to the surface of the photosensitive drum 31.

The base toner B, which has been charged with static electricity by the stirring, is selectively attached to the latent image X on the photosensitive drum 31 from the developing roller 35, and a developing layer Y is formed as a toner pattern. Subsequently, the releasing sheet P is fed in synchronism with the rotational movement of the developing layer Y in such a manner that the developing layer Y and the releasing sheet P are overlapped with each other and guided into a position in contact with the transfer roller 37.

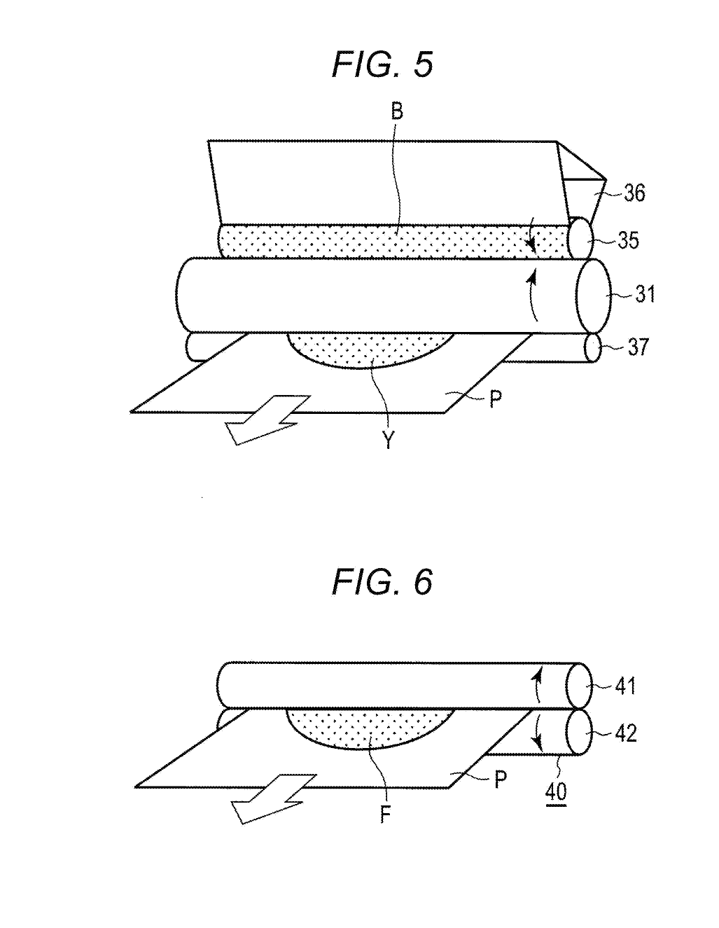

As shown in FIG. 5, the releasing sheet P is sandwiched between the photosensitive drum 31 and the transfer roller 37, and the developing layer Y is transferred to the releasing sheet P by a toner adsorption potential applied to the transfer roller 37. After the transfer, extra base toner B attached on the surface of the photosensitive drum 31 is removed by the doctor blade 32.

The image forming units 30 repeatedly execute the process from the charging to the removal of extra toner, and the toner is transferred on the releasing sheet P as the developing layer Y.

Similar operations are carried out in the image forming units 30B and 30C as well to respectively attach the base toners B having different colors to the releasing sheet P. The similar operation is carried out even in the image forming unit 30D, except that the film toner is used as the toner.

Finally, the developing layer Y and the releasing sheet P are made to pass through the fixing unit 40, as shown in FIG. 6, where heat and pressure are applied by the fixing rollers 41 and 42. Thus, the base toners B and the film toner, which form the developing layer Y, are melted and fixed, and then fixed onto the releasing sheet P. Specifically, a resulting thermal transfer film F is releasably supported on the releasing sheet P. Thus, the thermal transfer print sheet S is manufactured.

The thermal transfer film F of the thermal transfer print sheet S is releasable from the releasing sheet P; however, if the surface energy of the fixing roller 41, which has been in contact with the upper face of the developing layer Y during the fixing process, is made smaller than that of the releasing sheet P, the thermal transfer film F can be discharged without being peeled off from the releasing sheet P even without using adhesives.

The oil application roller 43 is used for the following reason. Specifically, the releasing sheet P has such a low surface energy that the development layer Y is hardly attached thereto. If, therefore, the developing layer Y is formed on the releasing sheet P by a typical electrophotographic printer or the like, the developing layer Y may be attached to the fixing roller 41 and offset from the releasing sheet P. In order to improve such an offset characteristic, the oil application roller 43 is made to abut the fixing roller 41 to take a measure to decrease the surface energy thereof. Preferably, silicone oil or the like is used.

Alternatively, this offset phenomenon can also be prevented in an oil-free manner such as by providing the surface of a fluorine-based resin on the fixing roller 41. To allow the prevention, it should suffice to set the surface energy of the fixing roller 41 to below the surface energy of the releasing sheet P to be used. Accordingly, the offsetting of the thermal transfer film F that has been adsorbed onto the releasing sheet P by electrostatic adsorption can be prevented.

In the apparatus 1 for manufacturing a thermal transfer print sheet, as described above, the plurality of image forming units 30 have been provided in tandem to transfer the developing layer Y repeatedly. The layer thickness of the developing layer Y of the single image forming unit 30 can be changed by setting different line velocities, etc. between the photosensitive drum 31 and the developing roller 35.

The layer thickness of the thermal transfer film after the transfer of the base toner or the film toner by a single image forming unit is typically from 20 to 50 μm, and preferably from 30 to 40 μm. By setting the layer thickness within this range, a practical tearing strength suitable for a post-thermal transfer-printing film can be obtained.

It is configured that solid printing can be done without dithers at all positions in the pattern printing during the production of the thermal transfer print sheet, and it has been modified to realize a maximum printing rate of 400% in four consecutive printings when the layers are formed on the condition that a 100% solid printing is carried out at each position. The layer thickness mentioned above is the layer thickness of the thermal transfer film to be provided when a 100% solid printing is carried out by the single image forming unit.

If the developing layer Y is transferred repeatedly, for example, three times by the image forming units, a resulting thermal transfer film would have a layer thickness smaller than a value to be obtained by simply multiplying the above layer thickness three times. However, as a mass has been increased almost three-fold, a density of the layers would differ from that of the single-layer structure.

In this embodiment, the primary transfer system has been adopted, but other transfer systems such as the secondary transfer system may be used so long as the above transfer amount (the layer thickness) can be obtained.

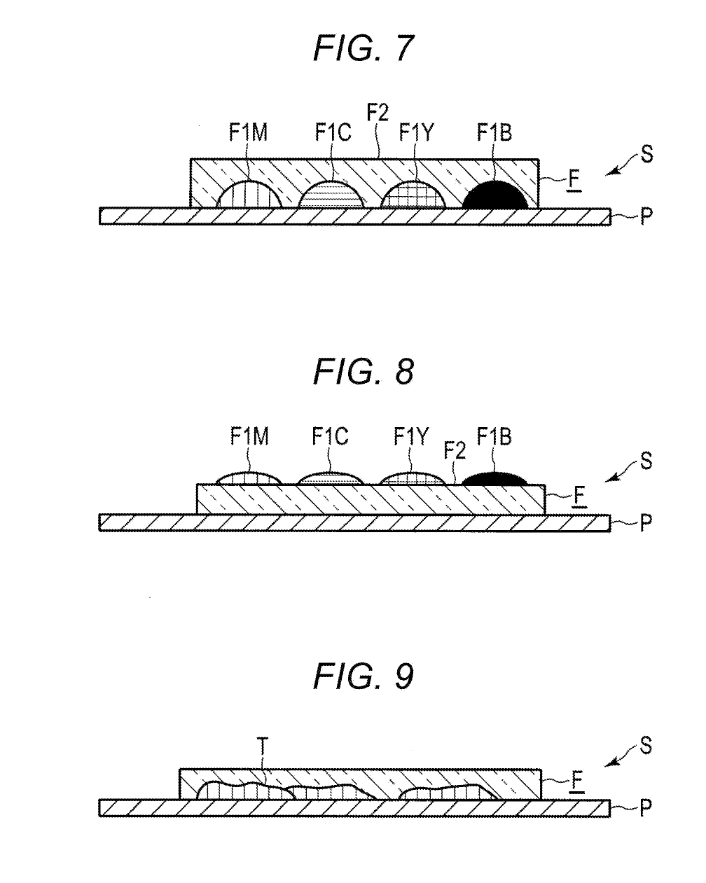

FIG. 7 shows an example of a thermal transfer print sheet S provided by using the above method. The thermal transfer print sheet S shown in FIG. 7 can be obtained by the above method, except that a black toner is additionally used as the base toner B.

The thermal transfer print sheet S includes a thermal transfer film F and a releasing sheet P. The thermal transfer film F is provided on the surface of the releasing sheet P having a releasing characteristic.

The thermal transfer film F includes a plurality of first patterns F1 and a second pattern F2.

The first patterns F1 are colored patterns formed by the base toners B of different colors for each pattern, and represent a foreground. F1M, F1C, and F1Y represent magenta, cyan, and yellow, respectively, and F1B represents a black colored pattern.

The second pattern F2 is used as a base material for supporting the first patterns F1. The second pattern F2 is formed by a transparent film toner having no color, and represents a background.

The black colored pattern F1B is provided herein, but it can be omitted. If the pattern made of the film toner is formed at the image forming unit 30A and the patterns made of the base toners B are formed in the image forming units 30B to 30D, as described above, the resulting thermal transfer film F has such a structure as shown in FIG. 8.

In the thermal transfer print sheet S shown in FIG. 7, the first patterns F1 are formed on the side where the thermal transfer film F touches the releasing sheet P. If it is desired to use a surface of the thermal transfer film F on the side of the releasing sheet P as a display surface, the patterns F1 are formed so that they appear to be reverse images when seen from the side of the thermal transfer film F opposite to the releasing sheet P. In this case, the pattern F2 may be non-transparent. If the surface of the thermal transfer film F on the side opposite to the releasing sheet P is used as the display surface, the patterns F1 are formed so that they appear to be normal images when seen from the above-mentioned side of the thermal transfer film F.

In the thermal transfer print sheet S shown in FIG. 8, a second pattern F2 is interposed between first patterns F1 and the releasing sheet P. If the surface of the thermal transfer film F on the side of the releasing sheet P is used as the display surface, the patterns F1 are formed so that they appear to be reverse images when seen from the surface of the thermal transfer film F opposite to the releasing sheet P. If the surface of the thermal transfer film F on the side opposite to the releasing sheet P is used as the display surface, the patterns F1 are formed so that they appear to be normal images when seen from the above-mentioned side of the thermal transfer film F. In this case, the pattern F2 may be non-transparent.

Next, the toner will be described. A film toner is made by mixing, melting, kneading, and crushing a binder resin and a charge control agent with typically a coloring agent and a mold release agent. A base toner is made by further adding a coloring agent of a corresponding desired color during the melting and kneading of the film toner.

A binder resin used in the base toner and the film toner is a thermoplastic resin generally used for films. Such a thermoplastic resin typically has a low glass transition temperature. Such a glass transition temperature (Tg) is, for example, 10° C. or less. To crush the thermoplastic resin having a low glass transition temperature, it is preferable to use freeze crushing.

A softening point of the binder resin used in the base toner and the film toner is not particularly limited so long as the above condition for the glass transition temperature is satisfied, but is typically from 95 to 145° C.

The binder resin used in the base toner includes a first thermoplastic resin as a major component. The resin used in the film toner includes a second thermoplastic resin as a major component. The fact that the binder resin includes a particular thermoplastic resin as a major component indicates that the thermoplastic resin has the largest weight ratio among other resin components contained in the binder resin. The weight ratio of the first thermoplastic resin relative to the binder resin of the base toner is, for example, 50% or more, and typically 80% or more. The weight ratio of the second thermoplastic resin relative to the binder resin of the film toner is, for example, 50% or more, and typically 80% or more. The binder resin of the base toner may include the first thermoplastic resin alone, while the binder resin of the film toner may include the second thermoplastic resin alone.

The first and second thermoplastic resins are generally used in films, and typically have a lower glass transition temperature. The glass transition temperature of the first and second thermoplastic resins is, for example, within the range mentioned above with regard to the binder resin. The softening point of the first and second thermoplastic resins is also within the range mentioned above with regard to the binder resin.

Specific examples of the first and second thermoplastic resins include a polybutylene succinate-based resin, a polyethylene-based resin, a polypropylene-based resin, a crystalline polyester-based resin, an EVA-based resin, a vinyl chloride-based resin, a polyvinylidene chloride-based resin, and a modified starch-based resin. Of these resins, the polybutylene succinate-based resin and the crystalline polyester-based resin are particularly preferable.

The first and second thermoplastic resins are “homologous”. The fact that the first and second thermoplastic resins are “homologous” indicates that each resin satisfies the conditions mentioned above. The first and second thermoplastic resins may be the same type of resin or different types of resins, so long as they are selected from the homologous resins.

Preferably, however, the first and second thermoplastic resins are based on the same substance. The fact that the first and second thermoplastic resins are “based on the same substance” indicates that both resins can be expressed by the same general term such as a polybutylene succinate-based resin, a polyethylene-based resin, a polypropylene-based resin, and a crystalline polyester resin.

The binder resin used in the base toner and the binder resin used in the film toner, respectively, may additionally include resins other than the first and second thermoplastic resins. Such resins include a polyester-based resin, a styrene acrylic-based resin, a rosin-based resin, and a terpene resin.

A charge control agent is added to control a charging amount and a charging speed of toner. Any charge control agent generally used for the electronic photographs may be used.

As a coloring agent, carbon black, for example, is the most suitable black coloring agent. Alternatively, organic black dyes and pigments may also be used. For white color, a while pigment of titanium oxide is preferably used. Alternatively, silica and cerium oxide may also be used as a white coloring agent, but titanium oxide is most preferably used in view of a coloring ability, cost, and ease of handling thereof.

For magenta, an organic pigment, such as a quinacridone-, naphthol-, or calcium lake-based pigment, or a rhodamine-based organic dye may be used.

For cyan, an organic pigment of copper phthalocyanine is suitable. Other phthalocyanine-based pigments such as the one using aluminum instead of copper, or a blue die, may also be used.

For yellow, an organic pigment such as a monoazo-, disazo-, isoindolino-, or benzimidazolon-based organic pigment, an organic dye, or an inorganic pigment such as bismuth vanadate may be used.

For a metallic color, a metallic luster color pigment may be used. For example, a pearl pigment made by coating mica, silica, alumina, or borosilicate glass with a metal oxide, such as titanium oxide, may be used.

For fluorescent color, a melamine-based organic fluorescent agent, or an inorganic fluorescent agent formed by several kinds of ceramics doped with a metal such as europium, manganese, terbium, or zinc may be used.

A mold release agent is added to prevent an offset phenomenon in which a portion of the toner is torn off and attached to the heating surface. Such phenomenon occurs in the course of fixing the developed toner on the releasing sheet by contact heat-fixing such as heat roller fixing. A mold release agent generally used for the toner for electronic photographs may be used. If it is not necessary to provide a mold release effect, the mold release agent may be omitted.

An average diameter of base toner particles is, for example, from 20 to 60 μm, and typically from 25 to 50 μm. An average diameter of film toner particles is from 20 to 60 μm, and typically from 25 to 50 μm. The “average diameter of particles (average particle diameter)” refers to a value obtained by a flow-particle-type image analysis.

### EXAMPLES

Examples of the present invention will be described below.

### Example 1

First, a (transparent) film toner was manufactured as follows. A polybutylene succinate-based resin, GS Pla@, manufactured by Mitsubishi Chemical Corporation (with a glass transition temperature (Tg) of −40° C.) was used as a thermoplastic resin. The thermoplastic resin was mixed with about 1% by mass of a charge control agent, LR147, manufactured by Japan Carlit Co., Ltd., relative to the entire quantity of internal additives, and about 2% by mass of a mold release agent, Carnauba Wax 1, imported by S. Kato & Co., relative to the entire quantity of internal additives, and the resulting mixture was subjected to melt-kneading. The melt-kneaded mixture was frozen and crushed in liquid nitrogen by Linlex Mill, manufactured by Hosokawa Micron Corporation, and the resulting filter pass particle diameter was 75 μm. An average particle diameter D50 (volume) of such powder was 48 μm.

Next, 100 parts by mass of the powder was mixed with 1 part by mass of hydrophobic silica, R972, manufactured by Nippon Aerosil Co. in the Henschel mixer, and a film toner a was obtained. An average particle diameter D50 (volume) of the toner was 48 μm, and a softening point thereof was 125° C.

To measure the particle diameter of the toner, FPIA-2100, manufactured by Sysmex Corporation, was used. Herein, a small amount of sample was put in a beaker with purified water and a surfactant, and the mixture was subjected to dispersion by an ultrasonic washing machine to provide a dispersion liquid, which was used for measurement. The measurement was carried out at an aperture size of 100 μm for 50,000 counts, and a volume average diameter (D50) was obtained.

To measure the softening point, CFT-500D manufactured by Shimadzu Corporation was used. The sample was 1 g, a temperature rise was 6° C/minute, and a load was 20 kg. A nozzle having a diameter of 1 mm and a length of 1 mm was used, and a temperature at which half of the sample was flowed, measured by the bisection method, was set as the softening temperature.

To measure the glass transition temperature (Tg), DSC6220, manufactured by the former SII Nanotechnology, was used. A temperature of the sample was raised to 150° C. at a temperature rising speed of 10° C., cooled to minus 70° C., held for 10 minutes, and raised to 150° C. again. At this time, a value at a shoulder part in the vicinity of an inflexion point of the heat sink curve was set to Tg.

The film toner a was set in the image forming unit 30A, while 100 parts by mass of the film toner a mixed with 4 parts by mass of magenta pigment (C. I. pigment red) (the mixture will be referred to hereinafter as “base toner a”) was set in the image forming unit 30B. No toner was set in the image forming units 30C and 30D.

Subsequently, the thermal transfer print sheet, which has been described above with reference to FIGS. 2 to 6, was manufactured. As the thermoplastic resins in the film toner and the base toner were homologous, the softening points thereof were close to each other. The fixing temperature herein was set to a temperature slightly higher than the softening points.

The resulting thermal transfer film had a layer thickness of about 33 μm as measured with a micrometer.

### Example 2

A thermal transfer print sheet was manufactured in a similar method as in Example 1, except that the base toner a was set in the image forming unit 30A instead of the film toner a, and the film toner a was set in the image forming unit 30B instead of the base toner a.

### Example 3

A film toner b was produced in a similar method as used for the film toner a in Example 1, except that crystalline polyester, GM-990, manufactured by Toyobo Co., Ltd. (with a glass transition temperature (Tg) of 1° C.) was used as the binder resin. The resulting film toner b was used to manufacture a thermal transfer print sheet. The particle diameter of the film toner b after the externally adding process was D50 (volume) 50 μm, and the softening point was 130° C.

### Comparative Example 1

A base toner b was produced as follows.

100 parts by mass of the binder resin, a polyester resin manufactured by Kao Corporation, 4 parts by mass of the coloring agent, Carmine 6B (No. 27), manufactured by Fuji Pigment, Co., Ltd., 3 parts by mass of the mold release agent, Carnauba Wax 1, imported by S. Kato & Co., and 1 part by mass of the charge control agent, LR147, manufactured by Japan Carlit Co., Ltd. were mixed and stirred by the Henschel mixer to obtain the base toner b.

A thermal transfer print sheet was manufactured in a similar method as in Example 1, except that the base toner b was set instead of the base toner a in the image forming unit 30B.

### Comparative Example 2

A thermal transfer print sheet was manufactured in a similar method as in Example 1, except that the base toner b was set instead of the film toner a in the image forming unit 30A, and the film toner a was set instead of the base toner a in the image forming unit 30B.

For each of the thermal transfer films obtained in Examples 1 to 3 and Comparative Examples 1 and 2, both ends of the film were picked and pulled. The strength of the films was then evaluated based on the resulting appearance thereof according to the following criteria.

Good: No breakage of the film or deformation of the image.

Average: No film breakage, but the image was unstable and deemed inappropriate as a product.

Poor: Film was torn off.

The results are shown in Table 1:

TABLE 1

| | Image Forming | Image Forming | |
|---|---|---|---|
| | Unit 30A | Unit 30B | Evaluation |
| Example 1 | Film Toner a | Base Toner a | Good |
| Example 2 | Base Toner a | Film Toner a | Good |
| Example 3 | Film Toner b | Base Toner a | Good |
| Comparative | Film Toner a | Base Toner b | Average |
| Example 1 | | | |
| Comparative | Base Toner b | Film Toner a | Poor |
| Example 2 | | | |

In Examples 1 to 3, the thermal transfer films having a desired shape and sufficient strength, and capable of being used as a practical product were provided. There were no problem in transferring and fixing when the thermal transfer print sheet obtained in each of Examples 1 to 3 was put on a cloth and subjected to transferring and fixing with an iron. Thus, the label having an excellent appearance and a sufficient strength was able to be attached to the cloth.

In contrast, in Comparative Examples 1 and 2, there was a difference in the softening state between the binder resin in the base toner b and the binder resin in the film toner a during the fixing process. It was, therefore, impossible to provide a sufficient adhering strength between the pattern made of the base toner b and the pattern made of the film toner a. Accordingly, the thermal transfer films of Comparative Examples 1 and 2 would easily be subject to peel-off and tear attributable thereto at an interface between the pattern made of the base toner b and the pattern made of the film toner a. Thus, the strength of the film and the stability of the image on the film were insufficient.

In Comparative Examples 1 and 2, when the fixing temperature was raised to sufficiently soften the binder resins of the base toner b and the film toner a, both the pattern made of the base toner b and the pattern made of the film toner a showed deformation. The base toner b is indicated by T in FIG. 9.

The fact that Comparative Example 1 showed somewhat better result than Comparative Example 2 was considered to have been caused by the following factors. Specifically, the charging characteristic of the film toner a was different from that of the base toner b, and such a charging characteristic, as well as the order of transferring the toner onto the releasing sheet P, affected relatively largely on the amount of toner to be transferred. In addition, the order of layering the patterns made of the base toner b and the film toner a, respectively, affected relatively largely on the melting state of the binder resin in the fixing process.

In the above Examples, the transparent film toner and the magenta base toner have been used, but various other coloring agents may be used so long as the first and second thermoplastic resins are homologous, and color materials for expanding image expressions, such as white and fluorescent colors, can also be used.

In the methods described above, because the toner patterns can be formed into desired shapes under the control of a computer, etc., a thermal transfer film having any shape can be provided even at a low cost, as a blade die is not necessary. Thus, a thermal transfer print sheet having a thermal transfer film that allows the use of various types of pigments and dyes as coloring agents, hardly causes tear, and has a practical strength can be manufactured.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

1. A method for manufacturing a thermal transfer print sheet, comprising the steps of:
forming a film pattern including a first pattern and a second pattern on a releasing sheet, one of the first and second patterns being arranged to at least partially overlap, the first pattern being formed of toner that includes a binder resin having a first thermoplastic resin, the second pattern being formed of toner that includes a binder resin having a second thermoplastic resin that is in a homologous relation to the first thermoplastic resin; and
applying heat to the film pattern such that the film pattern is formed as a thermal transfer film releasably supported on the releasing sheet.

2. The method for manufacturing a thermal transfer print sheet according to claim 1, further comprising the step of:
forming the film pattern without using a coloring agent in the toner used for the second pattern, such that the first pattern is visible from a side where the releasing sheet of the thermal transfer film is provided and also from an opposite side thereof, when the thermal transfer film is peeled off from the releasing sheet.

3. The method for manufacturing a thermal transfer print sheet according to claim 1, further comprising the step of:
forming the film pattern using a coloring agent in the toner used for the second pattern, such that the first pattern is invisible either from a side where the releasing sheet of the thermal transfer film is provided or from an opposite side thereof, when the thermal transfer film is peeled off from the releasing sheet.

4. The method for manufacturing a thermal transfer print sheet according to claim 1, further comprising the step of:
forming a color film pattern using the first pattern formed by more than one type of color toners by adding a coloring agent in the toner used for the first pattern.

5. The method for manufacturing a thermal transfer print sheet according to claim 1, wherein
the first and second thermoplastic resins are selected from the group consisting of a polybutylene succinate resin, a polyethylene resin, a polypropylene resin, a crystalline polyester resin, and a derivative thereof.

6. The method for manufacturing a thermal transfer print sheet according to claim 2, further comprising the step of:
forming a color film pattern using the first pattern formed by more than one type of color toners by adding a coloring agent in the toner used for the first pattern.

7. The method for manufacturing a thermal transfer print sheet according to claim 2, wherein
the first and second thermoplastic resins are selected from the group consisting of a polybutylene succinate resin, a polyethylene resin, a polypropylene resin, a crystalline polyester resin, and a derivative thereof.

8. The method for manufacturing a thermal transfer print sheet according to claim 3, further comprising the step of:
forming a color film pattern using the first pattern formed by more than one type of color toners by adding a coloring agent in the toner used for the first pattern.

9. The method for manufacturing a thermal transfer print sheet according to claim 3, wherein
the first and second thermoplastic resins are selected from the group consisting of a polybutylene succinate resin, a polyethylene resin, a polypropylene resin, a crystalline polyester resin, and a derivative thereof.

10. The method for manufacturing a thermal transfer print sheet according to claim 4, wherein
the first and second thermoplastic resins are selected from the group consisting of a polybutylene succinate resin, a polyethylene resin, a polypropylene resin, a crystalline polyester resin, and a derivative thereof.

11. The method for manufacturing a thermal transfer print sheet according to claim 6, wherein
the first and second thermoplastic resins are selected from the group consisting of a polybutylene succinate resin, a polyethylene resin, a polypropylene resin, a crystalline polyester resin, and a derivative thereof.

12. The method for manufacturing a thermal transfer print sheet according to claim 8, wherein
the first and second thermoplastic resins are selected from the group consisting of a polybutylene succinate resin, a polyethylene resin, a polypropylene resin, a crystalline polyester resin, and a derivative thereof.

13. The method for manufacturing a thermal transfer print sheet according to claim 1, further comprising the step of:
applying also pressure to the film pattern on the releasing sheet, when the film pattern on the releasing sheet is applied heat.

14. An apparatus for manufacturing a thermal transfer print sheet, comprising:
an image forming unit configured to form a film pattern including a first pattern and a second pattern on a releasing sheet, one of the first and second patterns being arranged to at least partially overlap, the first pattern being formed of toner that includes a binder resin having a first thermoplastic resin, the second pattern being formed of toner that includes a binder resin having a second thermoplastic resin that is in a homologous relation to the first thermoplastic resin; and
a fixing unit configured to apply heat to the film pattern such that the film pattern is formed as a thermal transfer film releasably supported on the releasing sheet.

15. The apparatus for manufacturing a thermal transfer print sheet according to claim 14, wherein
the image forming unit forms the film pattern without using a coloring agent in the toner used for the second pattern, such that the first pattern is visible from a side where the releasing sheet of the thermal transfer film is provided and also from an opposite side thereof, when the thermal transfer film is peeled off from the releasing sheet.

16. The apparatus for manufacturing a thermal transfer print sheet according to claim 14, wherein
the image forming unit forms the film pattern using a coloring agent in the toner used for the second pattern, such that the first pattern is invisible either from a side where the releasing sheet of the thermal transfer film is provided or from an opposite side thereof, when the thermal transfer film is peeled off from the releasing sheet.

17. The apparatus for manufacturing a thermal transfer print sheet according to claim 14, wherein
the image forming unit forms a color film pattern using the first pattern formed by more than one type of toners by adding a coloring agent in the toner used for the first pattern.

18. The apparatus for manufacturing a thermal transfer print sheet according to claim 14, wherein
the first and second thermoplastic resins are selected from the group consisting of a polybutylene succinate resin, a polyethylene resin, a polypropylene resin, a crystalline polyester resin, and a derivative thereof.

19. The apparatus for manufacturing a thermal transfer print sheet according to claim 14, wherein
the fixing unit is also configured to apply pressure to the film pattern on the releasing sheet.
